(19) United States
(12) Patent Application Publication
(10) Pub. No.: US 2014/0132985 A1
(43) Pub. Date: May 15, 2014

(54) IMAGE FORMING APPARATUS

(71) Applicant: Konica Minolta, Inc., Tokyo (JP)

(72) Inventor: Tetsu KAWASAKI, Tokyo (JP)

(73) Assignee: Konica Minolta, Inc., Tokyo (JP)

(21) Appl. No.: 14/069,914

(22) Filed: Nov. 1, 2013

(30) Foreign Application Priority Data
Nov. 9, 2012 (JP) 2012-247926

(51) Int. Cl. H04N 1/00

(52) U.S. Cl. CPC H04N 1/0044
USPC 358/1.15

(57) ABSTRACT

To restrain generation of waste sheets and a decrease in production efficiency as much as possible in sample sheet discharge, provided is an image forming apparatus including an image forming unit for forming an image on a sheet, an image read unit for reading the output image on the sheet on which the image has been formed, an operation/display unit for providing operation and display, and a control unit for controlling the image forming apparatus, where the control unit can display a screen image of the output image read by the image read unit on the operation/display unit for check by a user, thereby saving of waste sheets and minimizing a decrease in the production efficiency, and efficiently checking the output image.

### BACKGROUND OF THE INVENTION

1. Field of the Invention

The present invention relates to an image forming apparatus which forms and outputs an image on a sheet.

2. Description of the Related Art

Conventionally, in an image forming apparatus which forms an image by using image data, and prints the image on a sheet, a user can set print conditions. The print conditions include an output number of copies, simplex/duplex print, a print sleet size, a copy scare, a copy density, and post processing methods such as stapling and punching. If the print conditions are set in this way, there is such a need that the user checks whether an output form intended by the user is obtained or not, and, if the output form is different from the form intended by the user, the user wants to reset or modify the print conditions as a result of the check.

Further, there is such a flow in the print of PP (production print) that an image state is checked before an actual print, and if the image state is OK, a transition to the actual output is made.

Conventionally, from this point of view, an image forming apparatus enabling a print for the check by the user before the ordinary print or during the print is proposed. An output function for this check is referred to sample sheet discharge and the like.

For example, according to Patent Application Laid-Open No. H8-197779, a print output of a test pattern is made at a constant cycle, and determination of a balance of color and the like based on test print output images is enabled.

Though the sample sheet discharge has such an advantage as the check by the user, such disadvantages as generation of wasteful sheets and a decrease in productivity are generated since it causes operation declines of print on sheets and actual outputs.

Conventionally, for example, Patent Application Laid-Open No. H10-283132 discloses such a system that print data is transmitted from a client to a multi-function machine between networks, and image data of a print result transmitted from the multi-function machine is displayed as a screen image n a monitor screed of the client, and the print can be checked on the client side.

Moreover, Patent Application Laid-Open No. 2010-101937 proposes an image forming apparatus for storing image data of a job image, displaying thumbnail images based on the stored image data on a display unit, and enabling a user to select images subject to sample sheet discharge from the thumbnail images.

However, the system disclosed in Patent Application Laid-Open No. H10-283132 simply enables the client side to check the print result of the print data generated on the client side, and does not enable check of images generated and output on the image forming apparatus side or on other clients.

Moreover, though the system disclosed in Patent Application Laid-Open No. 2010-101937 simplifies the selection of the images subject to the sample sheet discharge, the check of the output image can be carried out only by the sample sheet discharge, and does not serve as means for avoiding a wasteful sheet discharge and a decrease in production efficiency.

### SUMMARY OF THE INVENTION

The present invention is made in view of the above situation, and has an object to provide an image forming apparatus for preventing the generation of wasteful sheets and the decrease of the production efficiency as much as possible, and enabling effective check of the output image.

Namely, to achieve at least one of the above-mentioned objects, an image forming apparatus reflecting a first aspect of the present invention comprises an image forming unit for forming, an image on a sheet, an image read unit for reading the output image on the sheet on which the image has been formed, an operation/display unit for providing operation and display, and a control unit for controlling the image forming apparatus.

wherein the control unit can display a screen image of the output image read by the image read unit on the operation/display unit.

The image forming apparatus according to a second aspect, in the first aspect, is characterized in that the screen image is displayed on the operation/display unit so that a user checks the output image.

The image forming apparatus according to a third aspect, in the first aspect, is characterized in that the control unit enables a display instruction for the screen image via the operation/display unit.

The image forming apparatus according to a fourth aspect, in the first aspect, is characterized in that the control unit displays a screen image of the output image read last by the image read unit as an initial display when the output image is displayed as the screen image.

The image forming apparatus according to a fifth aspect, in the fourth aspect, is characterized in that the control unit updates the display of the operation/display unit if the image read unit reads a new output image while the screen image of the output image is displayed on the operation/display unit, and displays a screen image of the newly read output image.

The image thrilling apparatus according to a sixth aspect, in the first aspect, is characterized in that the control unit displays a screen image of the output image read first by the image read unit in a specific job as an initial display when the output image is displayed as the screen image.

The image forming apparatus according to a seventh aspect, in the first aspect, is characterized in that the control unit enables specification of a specific output job via the operation/display unit relating to the display, and enables display of the screen image of the output image in a job relating to the specification on the operation/display unit.

The image forming apparatus according to an eighth aspect, in the first aspect, is characterized in that the control unit enables specification of an arbitrary JOB/copy number/page via the operation/display unit relating to the display, and enables display of the screen image of the output image in a page relating to the specification on the operation/display unit.

The image forming apparatus according to a ninth aspect, in the first aspect, is characterized in that the control unit enables, based on a specification of an arbitrary cycle, display of a screen image of an output image of a subject page on the operation/display unit.

The image forming apparatus according to a tenth aspect, in the ninth aspect, is characterized in that the arbitrary cycle is any one of a number of sheets, a time, and a number of JOBs.

The image forming apparatus according to an eleventh aspect, in the first aspect, is characterized in that the control unit enables, based on a specification of a specific condition, display of a screen image of an output image on a page matching the condition on the operation/display unit.

The image forming apparatus according to a twelfth aspect, in the eleventh aspect, is characterized in that the specific condition includes one or more conditions out of an operating user, an output mode, and an output destination.

The image forming apparatus according to a thirteenth aspect, in the ninth aspect, is characterized in that the control unit enables the specification via the operation/display unit.

The image forming apparatus according to a fourteenth aspect, in the first aspect, is characterized in that the control unit causes the image read unit to read all output images.

The image forming apparatus according to a fifteenth aspect, in the first aspect, is characterized in that the control unit enables a specification of a page for which the output image is read via the operation/display unit, and causes the image read unit to read the output image when the specified page is output.

The image forming apparatus according to a sixteenth aspect, in the first aspect, is characterized in that the control unit enables reprint of the output image displayed on the operation/display unit via the operation/display unit.

The image forming apparatus according to a seventeenth aspect, in the sixteenth aspect, is characterized in that the control unit enables selection whether the reprint is output as an interruption JOB or a normal JOB via the operation/display unit.

The image forming apparatus according to an eighteenth aspect, in the first aspect, is characterized in that the control unit enables a specification of a specific portion of the screen image via the operation/display unit, and enables display of image density information of the specified portion on the operation/display unit.

The image forming apparatus according to a nineteenth aspect, in the first aspect, is characterized in that the control unit enables a specification of a specific portion of the screen image via the operation/display unit, and enables listing of image density information on an other page on which the same image as the image on a page relating to the specification is printed on the operation/display unit.

The image forming apparatus according to a twentieth aspect, in the nineteenth aspect, is characterized in that the other page is the same page in a different copy from that of the page relating to the specification.

The image forming apparatus according to a twenty-first aspect, in the nineteenth aspect, is characterized in that the control unit enables a specification of an arbitrary page in the list via the operation/display unit, and enables display of a screen image of an output image of the specified page.

The image forming apparatus according to a twenty-second aspect, in the first aspect, is characterized in that the control unit enables a change of a display scale of the screen image of the output image displayed on the operation/display unit via the operation/display unit, and, if the screen image having the changed display scale exceeds a display area of the operation/display unit, enables a specification of an area of the screen image to be displayed on the display area.

The image forming apparatus according to a twenty-third aspect, in the first aspect, is characterized in that before all pages in a job have been output, the control unit enables display of a screen image of an output image read by the image read unit for a page already output in the job on the operation/display unit.

The image forming apparatus according to a twenty-fourth aspect, in the first aspect, is characterized in that the control unit has a sample sheet discharge function, and enables a user to select either one of or both of the sample sheet discharge and screen image display of the output image read by the image read unit.

### BRIEF DESCRIPTION OF THE DRAWINGS

In the accompanying drawings:

FIG. 1 is a diagram showing an overview of an image forming apparatus according to an embodiment of the present invention;

FIG. 2 is a diagram showing control blocks according to the embodiment of the present invention;

FIG. 3 is a diagram showing an overview of the image forming apparatus according to another embodiment of the present invention;

FIG. 4 is a flowchart showing sequence during print according to the embodiment of the present invention;

FIG. 5 is a diagram describing an overview of an output image screen image management table according to the embodiment of the present invention;

FIG. 6 is a flowchart showing a display sequence of an output image screen image, and a processing sequence of an operation input in response to the display according to the embodiment of the present invention;

FIG. 7 is a diagram showing an output image screen image display selection screen for selecting a display method of the input image screen image according to the embodiment of the present invention;

FIG. 8 is a diagram showing an output imago screen image display screen according to the embodiment of the present invention;

FIG. 9 is a diagram showing a screen of an example of a display change on the output image screen in display screen according to the embodiment of the present invention;

FIG. 10 is a flowchart showing a processing sequence depending on each selected content of output image screen image display methods according to the embodiment of the present invention;

FIG. 11 is a diagram showing an output image screen image display JOB selection screen for selecting a job subject to the output image screen image according to the embodiment of the present invention;

FIG. 12 is a diagram showing an output image screen image display page selection screen for selecting a page subject to the output image screen image according to the embodiment of the present invention;

FIG. 13 is a diagram showing an output image screen image display cycle selection screen for selecting as cycle of the display of the output image screen image according to the embodiment of the present invention;

FIG. 14 is a diagram showing an output image screen image display condition selection screen for selecting a condition of the display of the output image screen image according to the embodiment of the present invention;

FIG. 15 is a flowchart showing a sequence of image density check processing for the output image according to the embodiment of the present invention;

FIG. 16 is a diagram showing an image density check screen for the output image according to the embodiment of the present invention;

FIG. 17 is a screen showing a list of image densities of the output images among different copies;

FIG. 18 is a diagram showing a setting screen for simultaneously using both sample sheet discharge and the screen image display of the output image according to another embodiment of the present invention; and

FIG. 19 is a flowchart showing a print processing sequence if the sample sheet discharge and the screen image display of the output image can be simultaneously used according to the other embodiment of the present invention.

### DETAILED DESCRIPTION OF THE PREFERRED EMBODIMENTS

A description will now be given of an image forming apparatus 1 according an embodiment of the present invention referring to accompanying drawings.

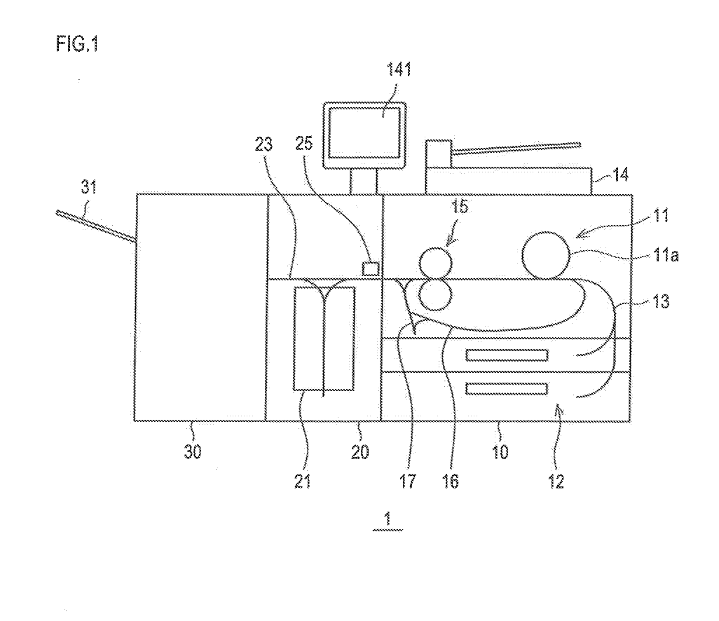

In the image forming apparatus 1, an image forming apparatus main unit 10 for carrying out image formation, a relay apparatus main unit 20, and a post-processing apparatus main unit 30 are sequentially connected with each other as shown in FIG. 1.

It should be noted that the connection configuration of the image forming apparatus according to the present invention is not limited to this configuration, and the image forming apparatus may be constructed only by the image forming apparatus main unit.

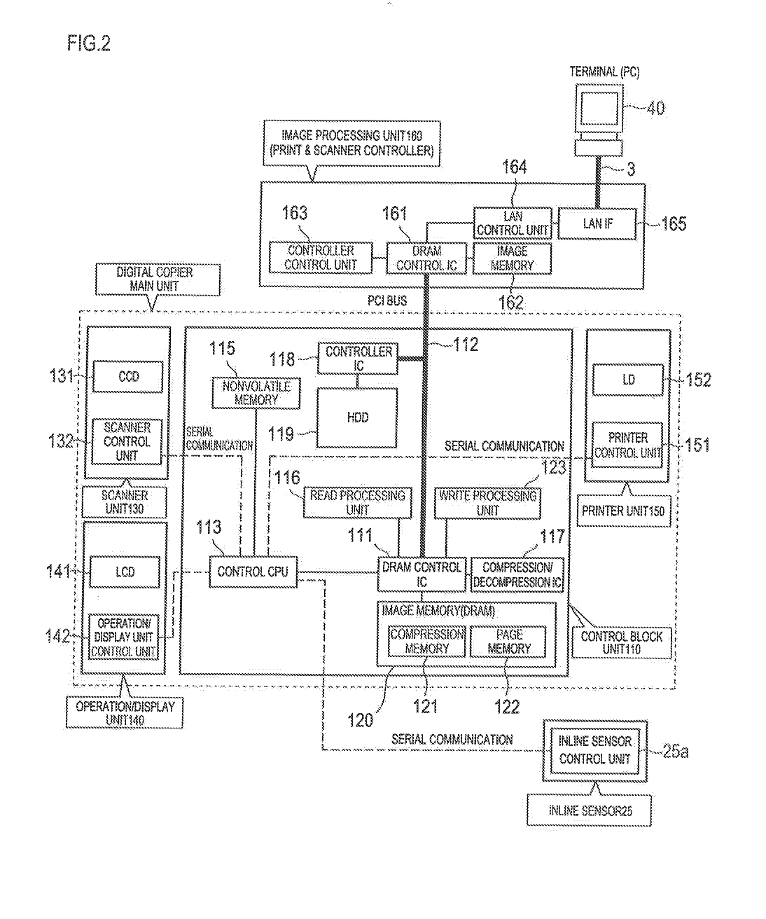

The image forming apparatus main unit 10 is provided with an automatic document feeding apparatus (ADF) 14 on a top side, and an image of a document fed by the automatic document feeding apparatus (ADF) 14 is read by a scanner unit 130 shown in FIG. 2. It should be noted that the document can be read also on a platen glass, which is not shown.

Moreover, an LCD 141 of an operation display unit 140 is provided on a top side of the image forming apparatus main unit 10 or the relay apparatus main unit 20 at a location where the platen glass is not positioned. The LCD 141 is constructed by a touch panel, can be operated by an operator, and can display information. The LCD 141 serves both as an operation unit and a display unit. It should be noted that the operation unit may be constructed by a mouse and a tablet, and can be constructed independently of the display unit. Moreover, the LCD 141 may be movable.

Multiple sheet feeding trays (two stages in the diagram) are disposed on the bottom side of the image forming apparatus main unit 10.

A transport path 13 for transporting a sheet fed from either one of the sheet feeding trays 12 is provided in the image forming apparatus main unit 10, and an image forming unit 11 is provided in the course of the transport path in the image forming apparatus main unit 10. The image forming unit 11 includes a photoreceptor 11a, an electrifier arranged around the photoreceptor 11a, and not shown, an LD, a developing apparatus, and a transfer unit, and a fixing apparatus 15 is further disposed on the transport path 13 on a downstream side of the photoreceptor member 11a.

The transport path 13 extends to connect to a transport path 23 of the relay apparatus main unit 20 on the downstream side of the fixing apparatus 15. Moreover, a turnover/transport path 16 which branches on the downstream side of the fixing apparatus 15, and merges with the transport path 13 on the upstream side of the image forming unit 11 is connected to the transport path 13. A turnover unit 17 for turning over a sheet is provided on the turnover/transport path 16. A sheet turned over by the turnover unit 17 can be flown back via the turnover/transport path 16 to the transport path 13 on the upstream side of the image forming unit 11, and, moreover, the turned sheet can be returned to the transport path 13 on the downstream side of the fixing apparatus 15 by switching the path, and can be transported directly to the relay apparatus main unit 20.

A surface of the photoreceptor 11a is uniformly electrified by the electrifier before the image writing, and a latent electrostatic image is formed on the photoreceptor 11a by irradiating a semiconductor laser on the photoreceptor 11a the surface of which is uniformly electrified by the LD in the image forming unit 11. The developing apparatus develops the electrostatic latent image formed by the LD on the photoreceptor 11a by a toner material. The development processing forms a toner image on the photoreceptor 11a. The transfer unit transfers the toner image on the photoreceptor 11a is onto the sheet transported from the sheet feeding tray 12. The sheet on which the toner image is transferred is separated from the photoreceptor 11a, and is transported to the fixing unit 15. The toner material remaining on the photoreceptor 11 to is removed by a cleaning unit which is not shown.

The fixing apparatus 15 fixes the toner image transferred onto a front surface side of the sheet by heating the transported sheet as an output image. The sheet to which the fixing processing is applied is transported to the relay apparatus main unit 20 by the transport path 13, or is turned over by the turnover unit 17 via the turnover/transport path 16, and then is flown back to the transport path 13 on the upstream side of the image forming unit 11. An image can be formed on a rear surface of the turned-over sheet by the image forming unit 11.

The relay apparatus main unit 20 includes the transport path 23 connected to the transport path 13, and connected to the post processing apparatus main unit 30 on the subsequent stage. The transport path 23 includes a turnover/stack unit 21 which can turnover the sheet transported on the transport path 23, or stacks a predetermined number of sheets. The sheets stacked by the turnover stack unit 21 can be transported to the post-processing apparatus main unit 30 side at a predetermined timing, and a sheet may be transported via the transport path 23 to the post-processing apparatus main unit 30 side without the sheet being stacked on the turnover/stack unit 21. Moreover, the sheet may be only turned over by the turnover/stack unit 21, and is transported again to the subsequent stage. An inline sensor 25 for detecting the output image on the sheet surface transported on the transport path 23 on an upstream side of the turnover/stack unit 21 is disposed on the transport path 23. The inline sensor 25 can detect the output image at a length corresponding to the maximum width of the sheet, and CCDs CMOSes arranged in a direction (such as an orthogonal direction) crossing the sheet transport direction. The inline sensor 25 corresponds to an image read unit according to the present invention.

Predetermined post-processing such as folding, saddle stitching, and stapling is carried out in the post-processing apparatus main unit 30. The post-processing apparatus main unit 30 includes post-processing units (not shown) corresponding to the respective pieces of predetermined post-processing, and predetermined post processing is applied according to post processing setting by the post-processing unit to the sheets transported from the relay apparatus main unit 20. If execution of the post processing is not set, the sheet can be discharged to a sheet discharge unit 31 without the post-processing.

A description will now be given of a functional configuration of the image forming apparatus 1 referring to FIG. 2.

The image forming apparatus main unit 10 includes a control block unit 110, the scanner unit 130, the operation/display unit 140, and a printer unit 150, and further includes an image processing unit (print and scanner controller) 160 which processes image data input from an external apparatus 40 such as the terminal PC via the LAN 3, and enables transport of the image data acquired by the scanner unit 130 via the LAN 3 to the external apparatus 40.

The control block unit 110 includes a PCI bus 112 connected to the image processing unit (print and scanner controller) 160, and a DRAM control IC 111 is connected to the PCI bus 112. An image memory (DRAM) 120 is connected to the DRAM control IC 111. The image memory (DRAM) 120 includes a compression memory 121 for storing compressed image data, and a page memory 122 for temporarily storing non-compressed image data subject to print before the image formation.

Moreover, an HDD (hard disk drive) 119 is connected via a controller IC 118 to the PCI bus 112, and image data acquired by the scanner unit 130, image data generated by the external apparatus 40 connected to the image processing unit (print and scanner controller) 160, and the like are stored in the HDD 119.

The image data acquired by the image processing unit (print and scanner controller) 160 and the image data stored in the HDD 119 are transmitted via the PCI bus 112 to the DRAM control IC 111 resulting from the print operation.

Moreover, the control block unit 110 is provided with a control CPU 113, and the DRAM control IC 111 is connected to the control CPU 113.

Moreover, a nonvolatile memory 115 constructed by a flash memory or the like is connected to the control CPU 113. Initial print setting information of the image forming apparatus-main unit 10, machine setting information such as process control parameters, initial data on output setting, specifications for reading the output image, setting relating to specification of display of a screen image of the read image, a program for operating the control CPU 113, and the like are stored in the non-volatile memory 115.

The control CPU 113 can read nonvolatile data in the nonvolatile memory 115, and can write desired data in the nonvolatile memory 115.

The control CPU 113 controls operations of the respective parts of the image forming apparatus main unit 10 according to the machine setting information, the print setting information, the output setting, and the like.

The control CPU 113 along with the nonvolatile memory 115 constructs the control unit according to the present invention, and controls the entire image forming apparatus 1.

The CPU 113 can carry out the output setting and operation instruction for a job via the operation display unit 140.

The scanner unit 130 is provided with a CCD 131 for optical reading, and a scanner control unit 132 for controlling the entire scanner unit 130. The scanner control unit 132 is connected to the control CPU 113 for serial communication. Moreover, the CCD 131 is connected to a read processing unit 116 for processing image data read by the CCD 131, and the read processing unit 116 is connected to the DRAM control IC 111 in a controllable manner.

The reading processing unit 116 applies various processing such as analog signal processing, A/D (Analog to Digital) conversion processing, and shading processing to an analog image signal input from the CCD 131 to generate digital image data, and outputs the digital image data to a compression/decompression IC 117.

The scanner unit 130 reads a document placed on the top platen glass of the image forming apparatus main unit 10, or a document automatically transported by the ADF 14 (document feeder).

The operation/display unit 140 serves both as the display unit and the operation unit, is provided with the LCD 141 constructed by the touch panel and an operation display unit control unit 142 for controlling the entire operation/display unit, and the operation/display unit control unit 142 is connected to the control CPU 113 for serial communication.

The operation/display unit 140 is controlled by the control CPU 113 to use the LCD 141 for a mechanical setting input such as output condition setting and operation control conditions in the image forming apparatus main unit 10, a setting input for sheet information (size and sheet type) in the respective sheet feeding trays, a display of setting contents, a display of desired information such as messages, a screen image display of the output image read by the inline sensor 25, and setting instruction, setting input, and display relating to the screen image display.

A compression/decompression IC 117 for compressing/decompressing image data is connected to the DRAM control IC 111. The DRAM control IC 111 controls compression processing for image data and decompression processing for compressed image data by the compression/decompression IC 117 according to an instruction from the control CPU 113, and carries out input/output control for image data to/from the image memory (DRAM) 120.

A write processing unit 123 is connected to the image forming unit 11 provided with the LD 152 of the printer unit 150, and generates write data used for an operation of the LD 152 based on image data.

The printer unit 150 is constructed by the image forming unit 11, the sheet feeding trays 12, the transport path 13, the turnover/transport path 16, the fixing apparatus 15, and the like.

Moreover, the printer unit 150 is provided with a printer control unit 151 for controlling the entire printer unit 150 (such as sheet feeding, image formation, sheet discharge, and the finishing), and the printer control unit 151 is connected to the control CPU 113 for serial communication. The printer control unit 151 operates according to a control instruction from the control CPU 113, and controls the printer unit 150 to carry out the sheet transport, the image formation, and the like.

Moreover, the DRAM control IC 161 for the image processing unit (print and scanner controller) 160 is connected to the PCI bus 112 to which the DRAM control IC 111 is connected as described above. The image processing unit (print and scanner controller) 160 receives image data and the like on the image forming apparatus main unit 10 from the external apparatus 40 connected to the LAN 3 and the like, and transmits the image data acquired by the scanner unit 130 to the external apparatus 40 connected to the LAN 3 and the like when the image forming apparatus main unit 10 is used as a network printer or a network scanner.

An image memory 162 constructed by a DRAM or the like is connected to the DRAM control IC 161 in the image processing unit (print & scanner controller) 160. Moreover, in the image processing unit (print and scanner controller) 160, the DRAM control IC 161, a controller control unit 163 for carrying out control for the entire image processing unit (print and scanner controller) 160, a LAN control unit 164, and a LAN interface 165 are connected to a common bus. The LAN interface 165 is connected to the LAN 3.

Further, an inline sensor control unit 25a for the inline sensor 25 disposed inside the relay apparatus main unit 20 is connected to the control CPU 113 for control, and an operation of the inline sensor 25 can be controlled via the inline sensor control unit 25a by the control CPU 113. Moreover, the result of reading by the inline sensor 25 can be received by the control CPU 113.

A description will now be given of a basic operation of the image forming apparatus 1.

First, a description will be given of a sequence for accumulating image data in the image forming apparatus main unit 10.

First, a description will be given of a case where an image is read by the scanner unit 130, thereby generating image data in the image forming apparatus main unit 10. The image is optically read by the CCD 131 from a document in the scanner unit 130. On this occasion, an operation of the CCD 131 is controlled by the scanner control unit 132 which receives an instruction from the control CPU 113. The document reading can be carried out while a document is being fed by the automatic document feeder (ADF) 14, or the document is placed on the platen glass.

The control CPU 113 operates according to a program, and issues an instruction based on an operation (such as read instruction and a copy instruction) on the operation/display unit 140 to the scanner unit 130. Data processing is applied to the image read by the CCD 131 by the read processing unit 116, and image data to which the data processing is applied is transmitted via the DRAM control IC 111 to the compression decompression IC 117, and is compressed by means of a predetermined method. The compressed data is stored via the DRAM control IC 111 in the image memory (DRAM) 120. If the data is to be stored in the HDD 119, the data once stored in the compression memory 121 is transmitted via the DRAM control IC 111 and the controller IC 11 to the HDD 119.

In addition thereto, the image data is input via the LAN 3 into the image forming apparatus main unit 10. As the image data, for example, image data generated by an application program in the external apparatus 40 or the like can be mentioned. The generation method for the image data is not specifically limited.

The image data is received in the LAN 3 and the LAN interface 165 by the image processing unit (print and seamier controller) 160, and is once stored in the image memory 162 by the DRAM control IC 161. The data stored in the image memory 162 is transmitted via the PCI bus 112 to the DRAM control IC 111, and is once stored in the page memory 122. The data stored in the page memory 122 is transmitted via the DRAM control IC 111 to the compression/decompression IC 117, undergoes the compression processing, and is stored via the DRAM control IC 111 in the compression memory 121. If the data is to be stored in the HDD 119, the data once stored in the compression memory 121 is transmitted via the DRAM control IC 111 and the controller IC 118 to the HDD 119.

When the image data is accumulated, output setting is carried out before or after the accumulation of the image data. The output setting can be carried out by an operation input by an operator while a setting screen which enables the operation input is displayed on the operation/display unit 140. Moreover, output setting items are selected in an initial setting, and even if the operator does not carry out the setting input, the output setting is also carried out by the initial setting.

When an image output is carried out in the image forming apparatus 1, namely the image forming apparatus 1 is used as a copier or a printer, the image data stored in the compression memory 121 is sent out via the DRAM control IC 111 to the compression/decompression IC 117, thereby decompressing the data, the decompressed data is sent out to the write processing unit 123, and writing is carried out by the LD unit 152 on the photoreceptor 11a electrified by the electrification unit. When the image data stored in the HDD 119 is used, the image data stored in the HDD 119 is once stored via the DRAM control IC 111 in the compression memory 121, the image data stored in the compression memory 121 is sent out via the DRAM control IC 111 to the compression/decompression IC 117, thereby decompressing the data, and the decompressed data is sent out to the write processing unit 123 as described above.

The printer control unit 151, which has received an instruction of the control CPU 113, controls respective units in the printer unit 150. A latent image written on the photoreceptor 11a is developed as a toner image by the developing unit, which is not shown, in the image forming unit 11, and the toner image is transferred by the transfer unit, which is not shown, onto a sheet supplied by the transport path 13, and is fixed by the fixing apparatus 15. On the photoreceptor 11a, after the toner image is transferred onto the sheet, remaining toner is removed by the cleaning unit, which is not shown.

Though a description is given of the embodiment assuming the monochrome image forming, the image forming apparatus main unit may be an image forming apparatus main unit including photoreceptors for respective colors (such as cyan, magenta, yellow, and black).

The sheet on which the image is formed is transported via the transport path 13 to the relay apparatus 20, is turned over by the turnover unit 17 of the turnover/transport path 16, and is transported via the transport path 13 to the relay apparatus main unit 20, or is transported on the turnover/transport path 16, and is then circulated to the transport path 13. The image forming and fixing are carried out on a rear surface side of the sheet circulated to the transport path 13, and the sheet is transported via the transport path 13 to the relay apparatus main unit 20.

Output images in part or entirety transported on the transport path 23 are read by the inline sensor 25 in the relay apparatus main unit 20, and the read image data is transmitted to the control CPU 113. The reading of the output image is carried out according to set instruction contents. The set contents are stored in the nonvolatile memory 115 or the like. Contents initially set or contents set by a user can be conceived as the instruction contents.

The sheet is stacked according to the setting by the turnover/stack unit 21, is directly transported on the transport path 23 to the post-processing apparatus main unit 30, or is turned over and transported to the subsequent stage. The sheet undergoes predetermined post-processing according to setting in the post-processing main unit 30, or is transported without post-processing, and is discharged to the sheet discharge unit 31 or the like respectively in these cases. Moreover, if the sheet is only turned over by the turnover/stack unit 21, and is transported to the subsequent stage, the output image formed on the rear surface side of the sheet can be read by the inline sensor 25. In this case, the sheet is turned over only for the reading. After the output image is read, the sheet is transported to the subsequent stage, is stacked in the turnover/stack unit 21, or is directly transported via the transport path 23, and is transported to the post-processing apparatus main unit 30.

Though a description is given of a case where the image read unit is provided on the apparatus on the subsequent stage of the image forming apparatus main unit 10, the image read unit may be provided on the image forming apparatus main unit.

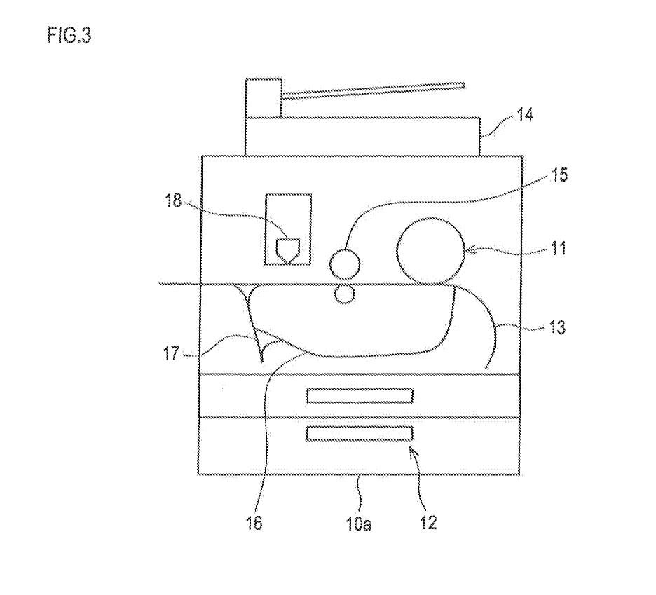

FIG. 3 shows such a configuration that an inline sensor 18 corresponding to the image read unit is provided on an image forming apparatus main unit 10a. The inline sensor 18 can be constructed as the inline sensor 25, and the inline sensor 18 also corresponds to the image read unit according to the present invention.

Another apparatus main unit may be connected to the image forming apparatus main unit 10a on a subsequent stage, or only the image forming apparatus main unit 10a constructs an image forming apparatus. Like components are denoted by like numerals as of the above-mentioned embodiment, a description thereof is thus omitted or simplified.

In this embodiment, the inline sensor 18 is disposed on the transport path 13 on the downstream side of the fixing apparatus 15 and on an upstream side of a position at which the turnover/transport path 16 branches from the transport path 13.

In this embodiment, even if images are formed on the front and the rear of the sheet, the sheet needs not to be turned over only for reading output images on the front and rear, and the output images on the front and rear of the sheet can be read by the inline sensor 18.

Namely, the sheet which has passed through the fixing apparatus 15 is led to the turnover/transport pad 16, and is turned over from front to rear by the turnover unit 17, and is then flown back to the transport path 13, resulting in formation of an image on the rear side of the sheet, and the image can be read by the inline sensor 18 on the downstream side of the fixing apparatus 15. A result of reading by the inline sensor 18 is transmitted to the control CPU 113.

The image can be read after the sheet has passed the fixing apparatus 15, and before the sheet reaches the turnover/transport path 16 in this form, and the sheet does not need to be turned over in order to read both surfaces by the inline sensor.

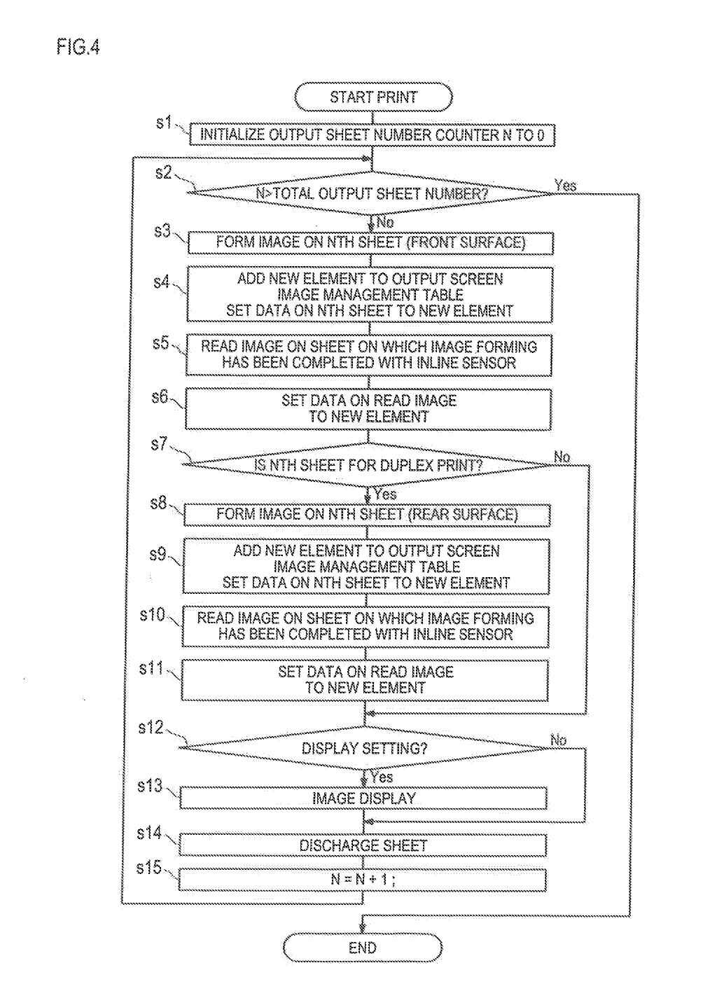

A description will now be given of a sequence of print on the image forming apparatus which can read output images on both surfaces of a sheet referring to a flowchart in FIG. 4. The following sequence is carried out by the control of the control CPU 113.

As the print (output) starts, an output sheet number counter N is set to 0 (Step s1), and it is determined whether N exceeds a total number of output sheets (Step s2). If N exceeds the total number of output sheets (Yes in Step s2) the processing is finished. If N does not exceed the total number of output sheets (No in Step s2) image forming for the Nth sheet (front surface) is carried out (Step s3). Then, a new element is added to an output image screen image management table, and the data on the Nth sheet is set to the new element (Step s4). Then, the inline sensor is caused to read the image on the sheet on which the image forming has been completed (Step s5). Data on the read image is set to the new element on the output image screen image management table (Step s6). The data on the read image is registered along with a JOB ID, a page number, a copy number, print setting data, and the like to the output image screen image management table as described later.

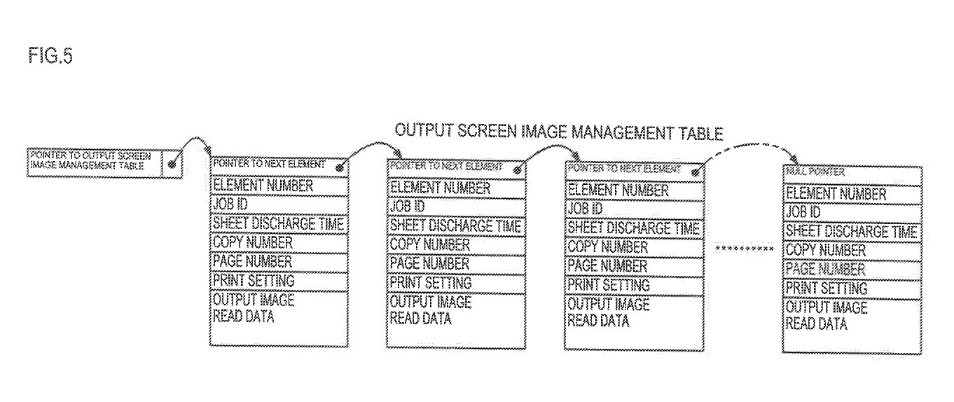

FIG. 5 is a diagram schematically showing the output image screen image management table. The output image screen image management table can be stored in the image memory (DRAM) 120 or the HDD 119 for reading and writing.

The table has a form of a list structure where an element is connected to a next element by means of a pointer, and a new element is added each time an output image is read.

The management table includes items such as pointers, element numbers, JOB IDs, sheet discharge times, copy numbers, page numbers, print settings, and read data of output images.
The element number is a serial number uniquely assigned to each element, and is used for managing the element.
The JOB ID, the copy number, and the page number are information on which JOB and which page the formed image corresponds to, and is used to search for an element when the output image screen image is displayed by specifying a subject page.
To the sheet discharge time, a time when the image forming was carried out is set, and is used to search for the element if an output image screen image is displayed at a cycle based on time.
To the print setting, conditions for the image forming (such as a color mode, a sheet size, a scale, a post-processing mode, and an output destination) are set, the conditions are used to search for a matching element when an output image screen image of a page matching specified conditions, and print conditions are set again when a reprint of a displayed page is instructed from an output image screen image display screen.
To the read data of output image, a screen image of an output image read by the inline sensor is set, and is used to display the output image screen image data on the operation/display unit,

The following various methods are conceivable for deletion of an element.
When a memory area which can be used by the system becomes full, elements are deleted starting from the top of the list (the oldest data).
An element corresponding to a page to which the user has declared completion of check of the output image is deleted from the list.

After Step s6, it is determined whether duplex print is carried out for the Nth sheet or not. Whether the duplex print is carried out or not is recognized by the control CPU 113 for controlling the image forming apparatus. If the duplex print is not carried out (No in Step s7), the processing proceeds to Step s12, and whether the image can be displayed or not is determined. If the duplex print is carried out (Yes in Step s7), image forming for the Nth sheet (rear surface) is carried out (Step s8), and a new element is added to the output image screen image management table as in the case of the front surface side, and data on the Nth sheet is set to the new element (Step s9). Then, the image of the sheet on which the image forming has been completed is read by the inline sensor (Step s10), and data on the read image is set to the new element in the output image screen image management table (Step s11). Namely, the data on the read image is registered along with a JOB ID, a page number a copy number, print setting data, and the like to the output image screen image management table.

Then, it is determined whether display setting for the screen image of the output image has been carried out by a display instruction by means of a display button or a push button by the user, or an initial instruction (Step s12). If the display setting has not been carried out (No in Step s12), the processing proceeds to Step s14 for discharging the sheet. If the display setting has been carried out (Yes in Step s12), the screen image of the output image is displayed on the operation/display unit 140 (Step s13). Then, the sheet discharge is carried out (Step s14), 1 is added to N (Step s15), and the processing proceeds to Step s2 for comparing the total number of output sheets and N with each other. Namely, the above-mentioned operation is carried out to all pages until all outputs have been completed.

Though the sequence is configured so that all the output images are read, the user may specify pages for which the output image check is to be carried out, and such a configuration that the reading is carried out by the inline sensor only when the image forming is carried out for the corresponding page is conceivable.

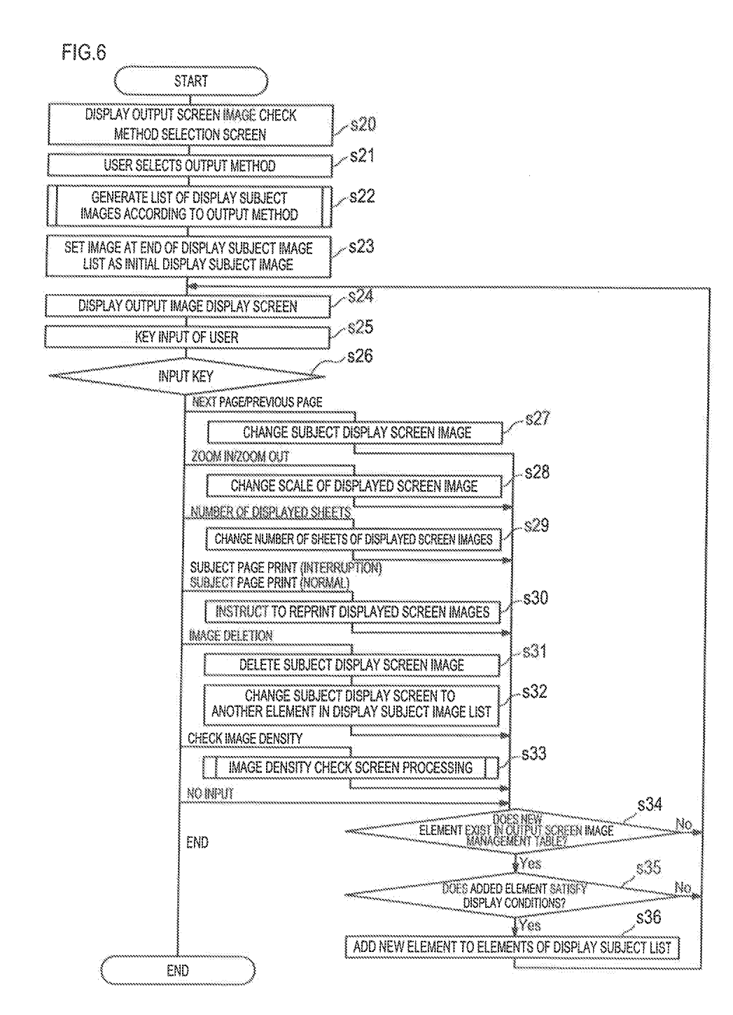

A sequence of screen image display processing of an output image when the user instructs the check of the output image screen image is shown in FIG. 6. The sequence is carried out by the control of the control CPU 113.

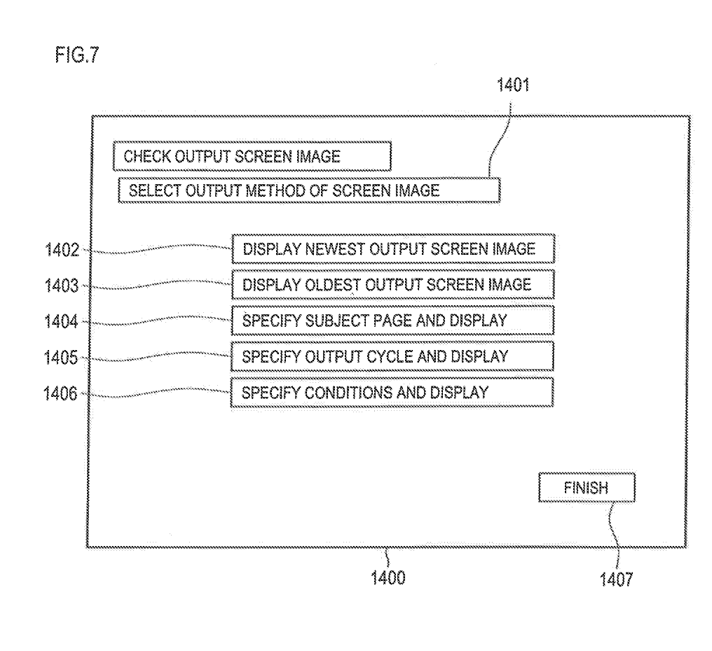

First, an output image screen image check method selection screen 1400 shown in FIG. 7 is displayed on the operation/display unit 140 (Step s20).

A message 1401 prompting selection of an output method for the screen image of the output image is displayed on the output image screen image check method selection screen 1400, and respective options are displayed for button depression, “Display newest output image screen image”, “display oldest output image screen image”, “specify subject page and display”, “specify output cycle and display”, and “specify conditions and display” can be selected as the options, and selection buttons 1402 to 1406 are displayed for button depression. Moreover, a finish button 1407 for finishing the processing is displayed for button depression.

The respective operations are carried out by depressing the respective buttons on the output image screen image check method selection screen 1400. A detailed description thereof will be described later.

When the user selects the output method on the output image screen image check method selection screen 1400 (Step s21), elements of output image screen images subject to display are searched for according to the selected display method, and a list of the display subject images is generated (Step s22).

In this example, a description is given of such a case that the selection button 1402 corresponding to “display newest output image screen image” is depressed in the output image screen image check method selection screen 1400.

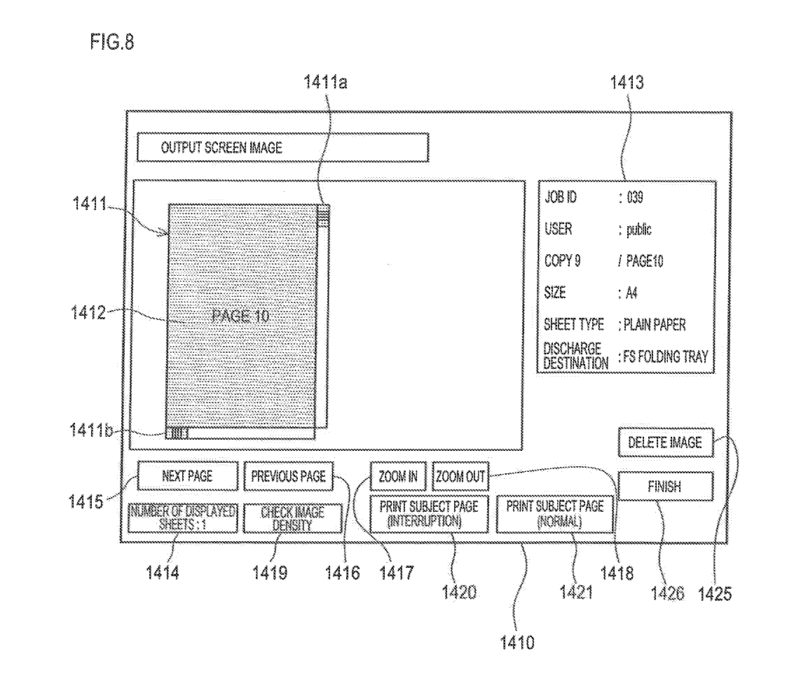

The last image at the end of the display subject image list is set as an initial display subject image (Step s23). Then, an output-image screen image display screen 1410 shown in FIG. 8 is displayed on the operation/display unit 140 based on the generated display subject image list, and processing in response to a key input by the user is carried out. In this example, the newest output ha e screen image read last is displayed, and reception of the key input starts.

Reading of a new image (addition of an element to the output image screen image table) is monitored until the key input is carried out, and when the new output image screen image is added, whether a screen image of the new output image is subject to display or not is determined, and the image is added to the display subject image list.

The image data can be acquired by referring to the end of the output image management table. When a new element is added to the output image management table, the display is updated to the screen image of the added element (or the user selects to update the display).

FIG. 8 shows an example of the output image screen image display screen 1410. The output image screen image display screen 1410 is provided with a screen image display field 1411, and an image screen image 1412 of a set subject page is displayed. In this example, a screen image 1412 relating to an output image of a page 10 at the end of the list is displayed. A vertical scrollbar 1411a and a horizontal scrollbar 1411b are displayed respectively at a right end of the screen image display field 1411 and a bottom end of the screen image display field 1411 for operation. If the entirety of the screen image 1412 does not fit into the display area of the screen image display field 1411, an area of the screen image displayed in the screen image display field 1411 can be changed by operating the vertical scrollbar 1411a and the horizontal scrollbar 1411b. If the entirety of the screen image 1412 fits into the screen image display field 1411, the vertical scrollbar 1411a and the horizontal 1 scrollbar 1411b may be set to be inoperable.

An output image information display field 1413 is provided on the right side of the screen image display field 1411, and information on the subject output image (such as a JOB for which the output is carried out, a number of copies, a number of pages, and a size) is displayed. A JOB ID, a user name, a copy number, a size, a sheet type, and the discharge destination are displayed in FIG. 8. The information is acquired by referring to data set to an element of the displayed output image.

A display sheet number setting field 1414 is provided for operation input on the lowest stage of the screen image display field 1411, and the number of sheets displayed in the screen image display field 1411 can be set in the display sheet number setting field 1414. In this example, “1” is set to the number of sheets in the display sheet number setting field 1414, and only a screen image of the page 10 is displayed in the screen image display field 1411. A next page button 1415 and a previous page button 1416 are displayed in parallel with each other for button depression on a lower stage of the screen image display field 1411 and on an upper stage of the display sheet number setting field 1414, and can change the page displayed on the screen image display field 1411. An image density check button 1419 is displayed for button depression on a lower stage the previous page button 1416, and on the right side of the display sheet number setting field 1414. A zoom in button 141 and a zoom out button 1418 for changing a display scale of the screen image are further displayed in parallel with each other for button depression on the right side of the previous page button 1416. A subject page print (interruption) button 1420 and a subject page print (normal) button 1421 are displayed in parallel with each other for button depression on a lower stage side thereof. The subject page print is carried out printing as sample sheet discharge. Moreover, an image deletion button 1425 and a finish button 1426 are displayed for button depression on a right end of a lower stage of the output image screen image display screen 1410.

If the user carries out a key input on the output image screen image display screen 1410 (Step s25), processing corresponding to the input key is carried out (Step s26), and the processing proceeds to Step s34 except when the finish button is depressed. The sequence is carried out by the control of the control CPU 113.

### Depression of the Next Page Button 1415

Switch to display of an image read one image after the displayed image (refer to an element one element after the displayed element, Step s27) is performed. If the displayed image is an image read last, no processing is carried out.

### Depression of the Previous Page Button 1416

Switch to display of an image read one image before the displayed image (refer to an element one element before the displayed element, Step s27) is performed. If an image other than the newest image (element at the last of the output image management table) is displayed, and new element is added to the table, update of display which the user does not want can be prevented by preventing the display from being updated

### Depression of the Zoom in Button 1417

The scale of the displayed image is changed so as to carry out zoom in display (Step s28). If the screen image cannot be displayed within the output image screen image display area, the user can select a display area of the screen image by the scrollbars. As a result, the display precision of the output image can be adjusted depending on a resolution of the screen.

### Depression of the Zoom Out Button 1418

The scale of the displayed image is changed so as to carry out zoom out display (Step s28).

### Operation Input on Display Sheet Number Setting Field 1414

The number of sheets of the output image screen images displayed can be changed by an input of the number of sheets (such as software ten keys and hardware keys) (Step s29). As a result, such an operation that multiple images can be arranged side by side, and can be compared, or front and rear images can be arranged side by side, and can be compared.

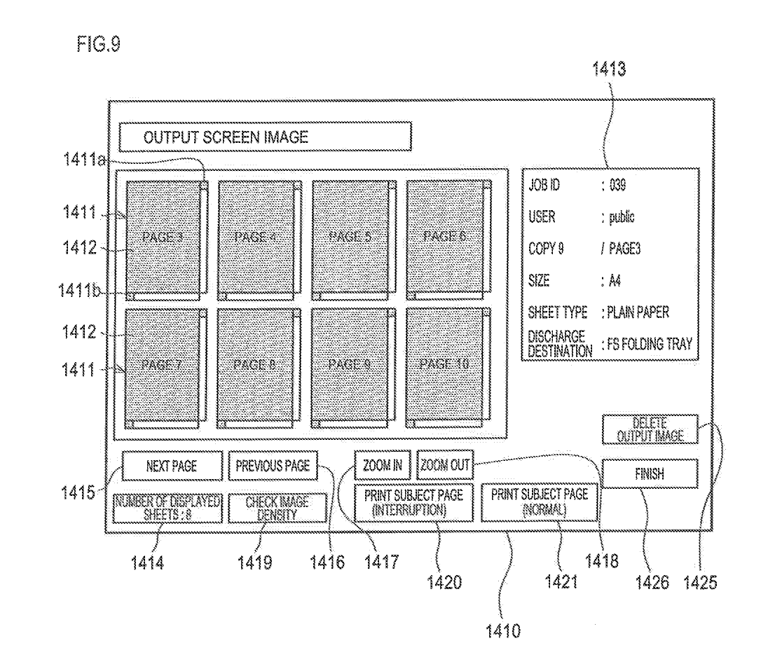

FIG. 9 shows the output image screen image display screen 1410 when the number of display sheets is set to 8, the output image screen image display screen 1410 has eight screen image display fields 1411, and the respective image screen images 1412 are displayed on the respective screen image display fields 1411. The vertical scrollbars 1411a and the horizontal scrollbars 1411b are respectively displayed for operation on the respective screen image display fields 1411.

Though the output image information on the right portion of the screen represents the oldest output image out of the output images being displayed in the form shown in FIG. 9, information on other output images may be displayed, or information on all the output images may be displayed side by side.

### Button Depression of Print (Interruption) Button 1420 for Subject Page

Button Depression of Print (Normal) Button 1421 for Subject Page

The depression of these print buttons enables the user to select and instruct either one of interrupt print or normal print of the subject page (page presently displayed) (Step s30). In the interruption print, a job is interrupted during execration of the job, and the subject page is printed, and in the normal print, the print is added to the last of a reserved JOB list.

As a result, a reprint when an abnormality is found in the cheek of an output image screen image, a print for saving the output image as a sample, and a check of an image if the sufficient check cannot be carried out on the screen can be carried out easily.

### Depression of the Image Deletion Button 1425

When the image deletion button 1425 is depressed, the screen image of the display subject image is deleted, and the output image screen image is deleted from the memory (a subject element is deleted from the output image management table) (Step s31), and the display subject screen image is changed to another element in the display subject image list (Step s32). The change is carried out depending on a screen image output method and the like.

### Depression of the Image Density Check Button 1419

When the image density check button 1419 is depressed, image density check screen processing is carried out (Step s33). A detailed description of the image density check screen processing will be described later.

### Depression of the Finish Button 1426

When the finish button 1426 is depressed, the processing is finished, the check of the output image screen image is finished, and transition to a menu screen for an upper level is carried out, for example.

If a key other than the finish button is input, or a key input is not present, the processing proceeds to Step s34.

It is determined whether a new element exists in the output image screen image management table or not in Step s34. If a new element does not exist (No in Step s34), the processing proceeds to Step s24, and the output image screen image screen 1410 is displayed. If a new element exists (Yes in Step s34), it is determined whether an added element satisfies display conditions (Step s35). If the added element does not satisfy the display conditions (No in Step s35), the processing proceeds to Step s24, and the output image screen image screen 1410 is displayed. If the added element satisfies the display conditions (Yes in Step s35), the new element is added to the elements of the display subject list (Step s36), the processing proceeds to Step s24, and the output image screen image display screen 1410 is displayed.

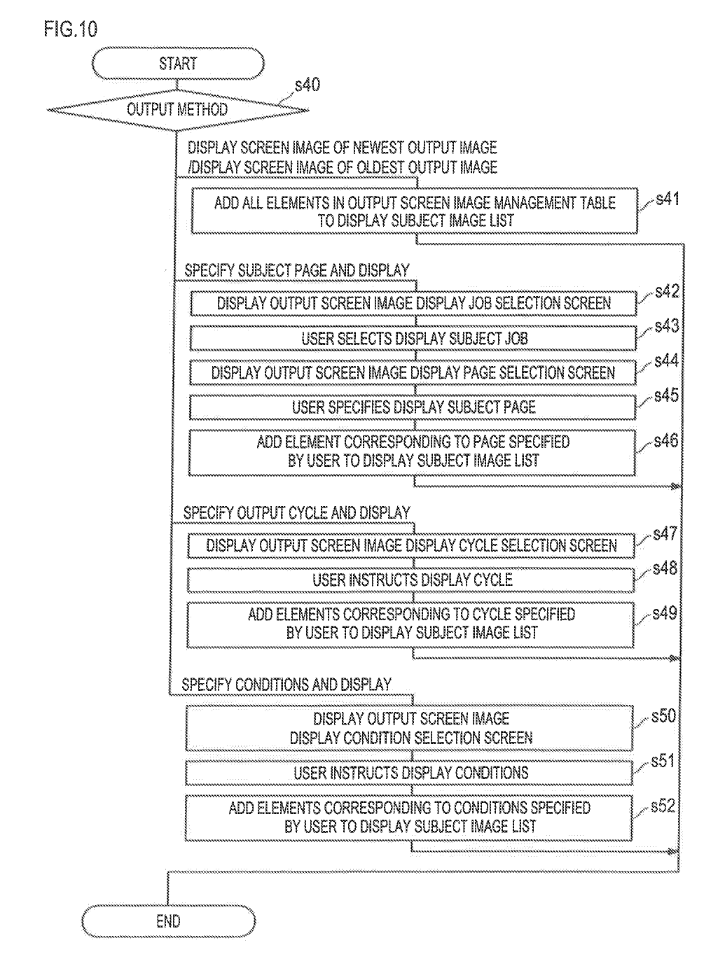

A detailed description will now be given of the selection of the output method in Step s21 referring to a flowchart in FIG. 10. It should be noted that the following sequence is carried out by the control of the control CPU 113.

As the output method, any one of “display newest output image screen image”, “display oldest output image screen image”, “specify subject page and display”, “specify output cycle and display”, and “specify conditions and display” can be selected as described before, and depression of the corresponding selection buttons 1402 to 1406 on the output image screen image check method selection screen 1400 causes the following sequences.

Depression of the selection button 1402 for “display newest output image screen image”, or depression of the selection button 1403 for “display oldest output image screen image”

### Selection of “Display Newest Output Image Screen Image”

The image read last by the inline sensor is checked (Step s41), and the processing is finished. This output method adds all the elements on the output image management table to the display subject image list, and if the operation to read an output image is carried out during the display of the image screen image, updates the display to the no nest image.

This output method for the screen image, abnormality of the image is checked in real time during the output of the image, and a misprinted sheet can be found early.

### Depression of the Selection Button 1403 for “Display Oldest Output Image Screen Image”

The image read first by the inline sensor is checked (Step s41), and the processing is finished. This output method adds all the elements on the output image management table to the display subject image list. For example, all the output images can be checked in the order of output.

### Depression of the Selection Button 1404 for “Specify Subject Page and Display”

A JOB, a copy number, and a page number are specified, and the subject page image is checked. Either all pages of a subject JOB or only an arbitrary page of the subject JOB can be displayed, a user who has instructed to print the subject JOB can check whether the printing was normal or not. Moreover only a specific image can be checked by specifying an arbitrary page in the JOB. For example, if only pages having photographs need to be checked, whether an image quantity varies depending on copy or not, for example, can be checked.

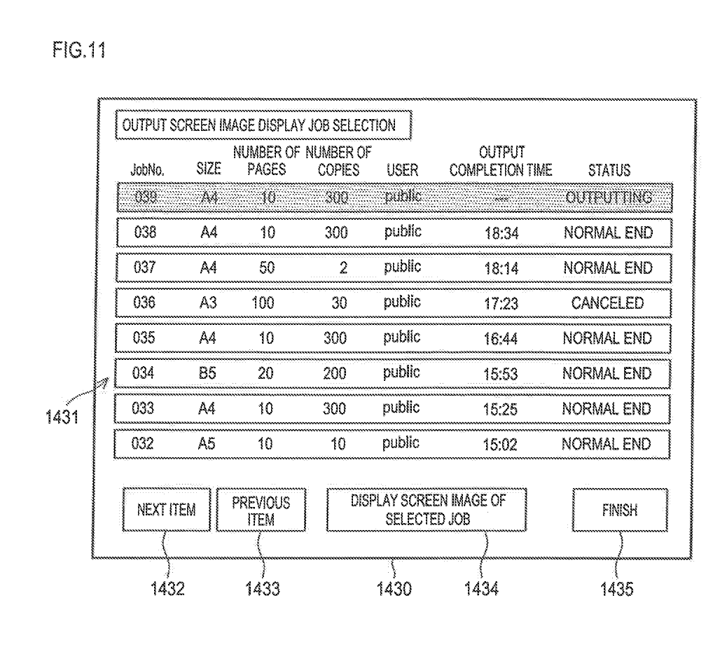

Specifically, an output image screen image display JOB selection screen 1430 shown in FIG. 11 is displayed, thereby permitting selection of a job subject to the screen image display of the output image (Step s42).

A history list of jobs for which the output has been carried out is listed in a history field 1431 on the output image screen image display JOB selection screen 1430, and a job can be selected by depressing a button on a row of a displayed job. In this example, jobs are displayed in a sequence starting from the newest one. When there is a job being output, the job is displayed at the top of the list. It should be noted that the display order is not limited to this case, The selected job is highlighted. Only one job may be selected, or multiple jobs may be selected.

A next item button 1432 and a previous item button 1433 are displayed as push buttons so as to be used to switch a display extent of the job list in the history field 1431 on the output image screen image display selection screen 1430.

Moreover, the “display screen image of selected JOB” button 1434 and a finish button 1435 are displayed for button depression on the output image screen image display selection screen 1430. If the finish button 1435 is depressed, the screen is closed, and a menu screen of an upper layer or the like is displayed.

If the “display screen image of selected JOB” button 1434 is depressed (Step s43), an output image screen image display page selection screen 1440 is displayed (Step s44).

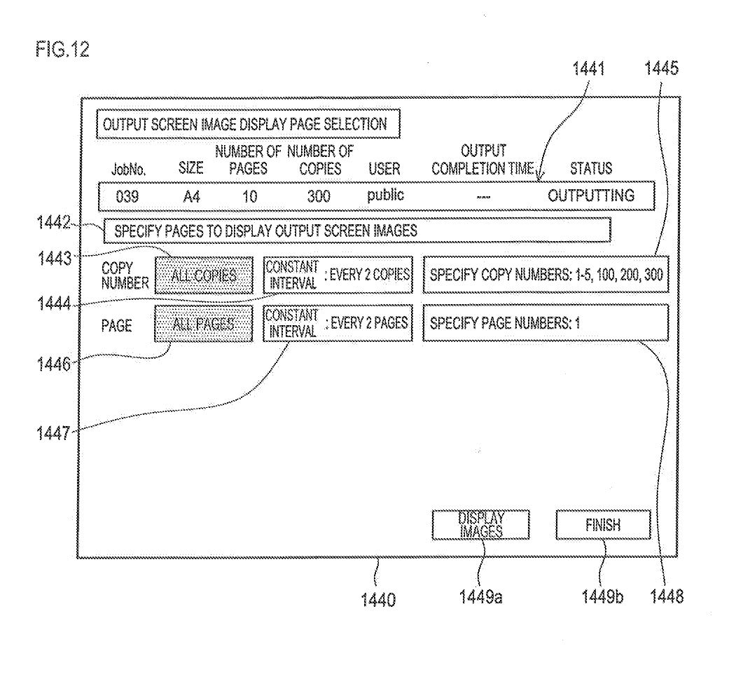

FIG. 12 shows an example of the output image screen image display page selection screen 1440. This screen permits arbitrary specification of a page in a subject job for which an output image is screen imageed. A selected job display field 1441 for displaying the selected job is provided on this screen, and the selected job can be confirmed. Moreover, a message prompting selection of a page to be screen imageed is displayed in a message field 1442.

Selection per copy or per page is available for the page selection, and all copies button 1443, a constant interval button 1444, and a copy number specification button 1445 are available as a push button or for a numerical input for the selection per copy. The constant interval button 1444 permits setting of an interval of a predetermined number of copies as displayed on the screen, and a screen image is displayed on the screen at a constant cycle for the check. The copy number specification button 1445 permits specification of copies at arbitrary positions in the sequence by a copy number or an extent of copies, and also permits multiple specifications.

An all pages button 1446, a constant interval button 1447, and a page number specification button 1448 are available as a push button or for a numerical input for the selection per page. The constant interval button 1447 permits setting of an interval of a predetermined number of pages as displayed on the screen. The page number specification button 1448 permits specification of arbitrary pages by a page number or an extent of pages. The selection by specifying a copy number and a page permits display of desired pages if only a start page is checked or only certain pages in each copy is checked.

A screen image display button 1449a, and a finish button 1449b are displayed for button depression on the output image screen image display page selection screen 1440. When the finish button 1449b is depressed, the screen is closed, and a menu screen of an upper layer or the like is displayed.

If the user specifies a display subject page on the screen (Step s45), and depresses the screen image display button 1449a (Step s46), an element corresponding to the page specified by the user is added to the display subject image list (Step s46), and the processing is finished. If the screen image display button 1449a is depressed, a screen image of the desired page can be displayed on the output image screen image display screen 1410 in FIG. 8 can be displayed.

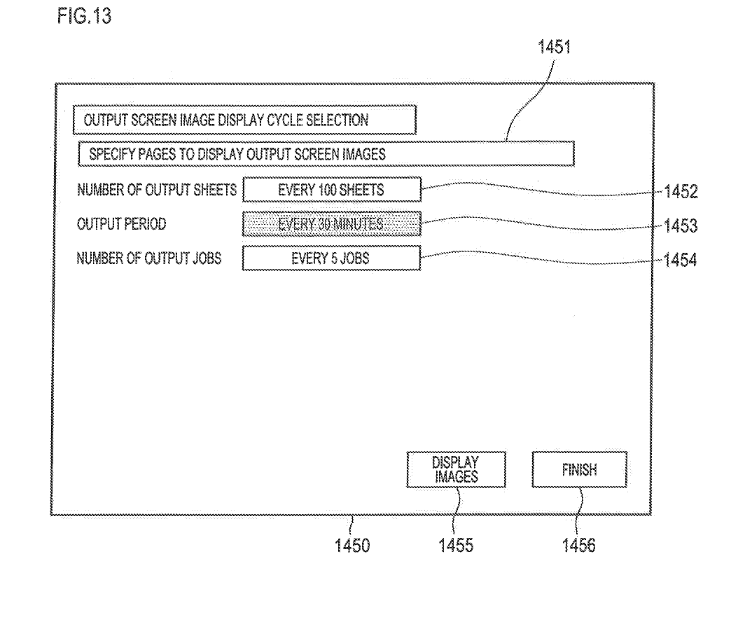

Moreover, if the selection button 1405 for “specify output cycle and display” is depressed on the output image screen image check method selection screen 1400, an output image screen image display cycle selection screen 1450 shown in FIG. 13 is displayed on the operation/display unit 140 (Step s47).

On this screen, the cycle can be specified as a cycle of a time, a number of sheets, or a number of JOBs, and images corresponding to the subject cycle can be checked. The check at the subject cycle enables check of a change in image quality on a machine due to aging, and storage and management of history samples of output images.

An example of the output image screen image display cycle selection screen 1450 is shown in FIG. 13. There is a massage field 1451 prompting specification of a page subject to the display of the screen image in FIG. 13.

Moreover, the cycle can be set for any one of the number of output sheets, the time cycle of output, and the number of output JOBs, a sheet number cycle setting button 1452, a time cycle setting button 1453, and a JOB number cycle setting button 1454 are displayed for receiving an operation input. The user can input on any one of the items, and the item on which the input is carried out is highlighted. A time cycle of 30 minutes is set as the time cycle in this example. Moreover, when the display cycle is set on the output image screen image display cycle selection screen 1450, and a screen image display button 1455 is depressed (Step s48), elements corresponding to the cycle specified by the user are added to the display subject image list (Step s49), and the processing is finished. If the time cycle is specified, the element is determined by means of a method selecting an element closest to, immediately before, or immediately after a time when the time cycle is set. When the finish button 1456 is depressed, the screen is closed, and a menu screen of an upper layer or the like is displayed.

If the screen image display button 1455 is depressed, a screen image of a desired page can be displayed on the output image screen image display screen 1410 in FIG. 8.

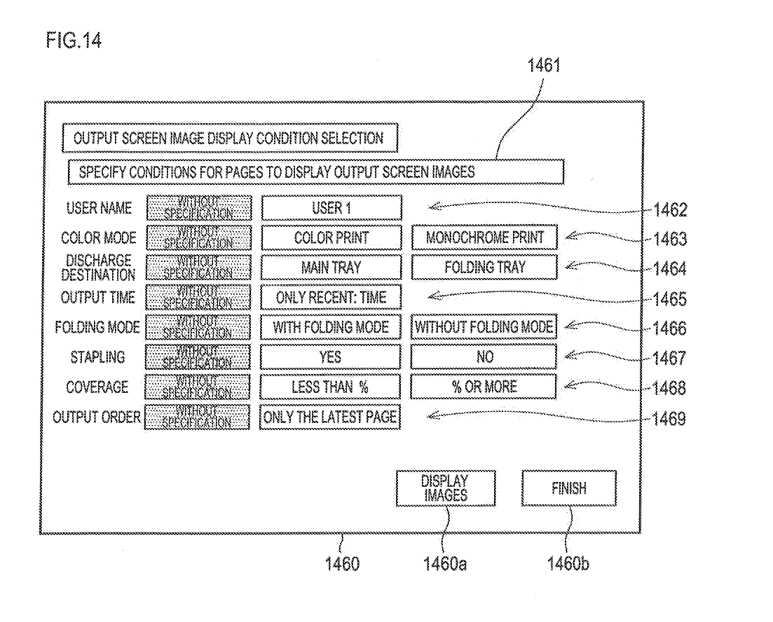

Moreover, if the selection button 1406 for “specify conditions and display” is depressed on the output image screen image check method selection screen 1400, an output image screen image display condition selection screen 1460 shown in FIG. 14 is displayed for accepting an operation input on the operation/display unit 140 (Step s50).

By specifying particular conditions on this screen (Step s51), page images matching the conditions can be checked. Elements matching the conditions specified by the user are added to the display subject image list (Step s52), and the processing is finished.

As examples of the conditions, the following conditions are conceivable.
Only a particular user→when a certain user checks only images output by the user
Only a particular discharge destination→when only a JOB images of which cannot be checked during the output is checked
Only a particular sheet discharge mode→when an image is checked in the course of print of a bundle of sheets
Only a particular setting→when only images on color pages are checked

By setting “only newest read page” to the condition, an output of a printed page corresponding to the condition can be checked in real time.

An example of the output image screen image display condition selection screen 1460 is shown in FIG. 14.

A message field 1461 for displaying a message prompting selection of conditions for pages for which screen images are displayed is provided on the screen.

Moreover, a user name specification item button 1462, a color mode specification item button 1463, a sheet discharge destination specification item button 1464, an output time specification item button 1465, a folding mode specification item button 1466, a stapling specification item button 1467, a coverage rate specification item button 1468, and an output sequence specification item button 1469 are displayed for accepting an operation input on the output image screen image display condition selection screen 1460.

Setting without specification and a particular specific setting are available on each of the items. Namely, no specification and specification of a particular user on the user name specification item button 1462, no specification and specification of a particular color on the color mode specification item button 1463, no specification and specification of a particular sheet discharge destination on the sheet discharge destination specification item button 1464, no specification and specification of a particular output time on the output time specification item button 1465, no specification and presence/absence of the folding mode on the folding mode specification item button 1466, no specification and presence/absence of the stapling on the stapling specification item button 1467, no specification and a particular threshold of a coverage rate on the coverage rate specification item button 1468, and no specification and a particular output sequence on the output sequence specification item button 1469 are available.

Moreover, a “display screen mage” button 1460a and a finish button 1460b are displayed for button depression on the output image screen image display condition selection screen 1460.

When display conditions are instructed by the user, and the “display screen image” button 1460a is depressed (Step s51), elements matching the conditions specified by the user are added to the display subject image list, and the processing is finished. When the finish button 1460b is depressed, the screen is closed, and a menu screen of an upper layer or the like is displayed.

If the “display screen image” button 1460a is depressed, a screen image of a desired page can be displayed on the output image screen image display screen 1410 in FIG. 8.

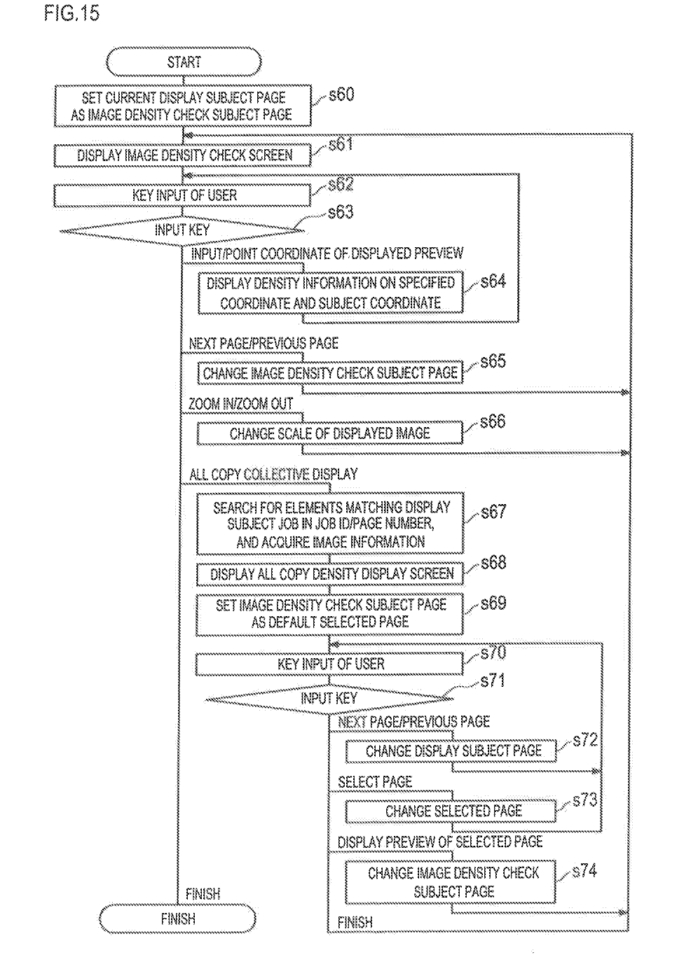

Referring to a flowchart FIG. 15, a description is no given of a sequence of image density check processing carried out when the image density check button 1419 is depressed on the output image screen image display screen 1410 in FIG. 8. It should be noted that the following sequence is carried out by the control of the control CPU 113.

As the processing starts, the current display subject page is set as an image density check subject (Step s60). Then, the image density check screen 1470 is displayed on the operation/display unit 140 (Step s61).

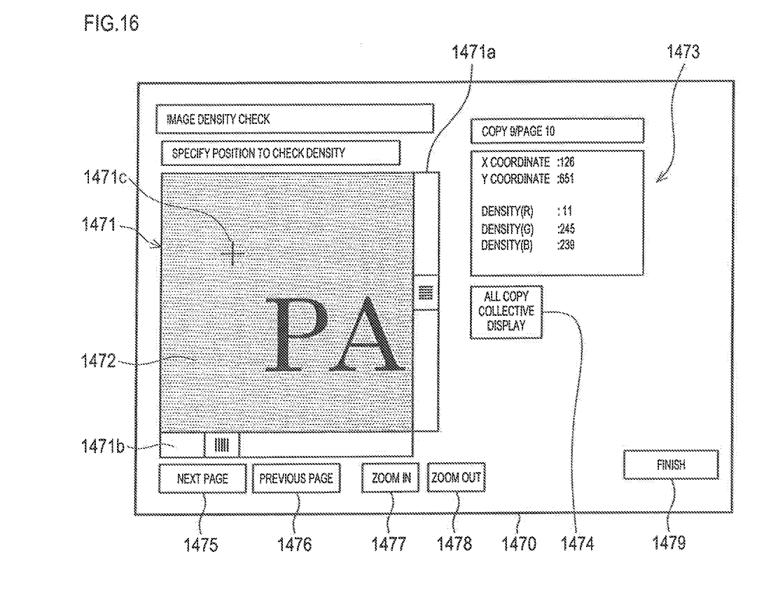

An example of the image density check screen is shown in FIG. 16. A screen image display field 1471 is provided on the image density cheek screen 1470, a vertical scrollbar 1471a is displayed on a right end of the screen image display field 1471, and a horizontal scrollbar 1471b is displayed on a bottom end of the screen image display filed 1471 for operation. An operation of the vertical scrollbar 1471a can vertically move an area of the screen image displayed on the screen image display field 1471, and an operation of the horizontal scrollbar 1471b can horizontally move a screen image displayed on the screen image display field 1471. Moreover, a pointer 14710 which can be moved or clicked for selection is displayed for operation on the screen image display field 1471.

Further, an information display field 1473 for showing a coordinate position of the pointer 1471c and image densities of the screen image 1472 corresponding to the coordinate position of the pointer 1471c is provided on the image density check screen 1470. The pointer 1471c is displayed on the information display field 1473 when the user touches, or specifies, by means of a mouse or a tablet, a specific location on the screen image display field 1471, and the coordinate of the pointed position and the image densities are displayed on the information display field 1473.

Moreover, an input screen for a coordinate may be displayed by depressing the button for the information display field 1473, and the user may directly input coordinate. Moreover, a density display subject may be instructed by an area (extent specification), not by a point, and averages of pixels in the subject area may be displayed. If the user does not specify an area, averages of pixels inside a certain distance from the specified point may be displayed.

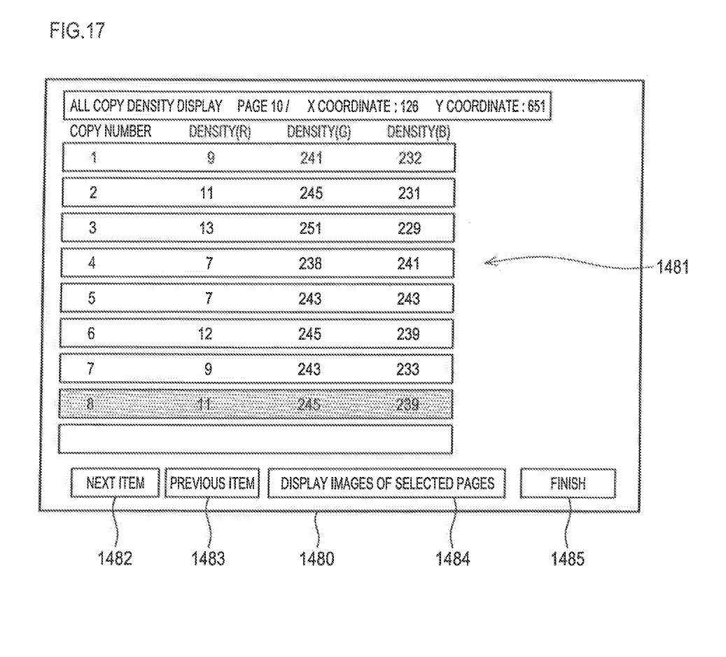

Moreover, an “all copy collective display” button 1474 is displayed for button depression on the screen density check screen 1470. An all copy density display screen 1480 shown in FIG. 17 is displayed by depressing the “all copy collective display” button 1474.

Moreover, a next page button 1475 and a previous page button 1476 are displayed in parallel for button depression on a lower stage of the screen image display field 1471 on the image density check screen 1470, and permit a change of the page relating to the screen image displayed on the screen image display field 1471. A zoom in button 1477 and a zoom out button 1478 for changing a display scale of the screen image are displayed in parallel for button depression on the right side of the previous page button 1476, thereby enabling the zooming in and out the screen image 1472 displayed on the screen image display field 1471.

A finish button 1479 is displayed for button depression on a right end of a lower stage of the image density check screen 1470, and the display of the screen can be finished by depressing the finish button 1479.

A screen example of the all copy density display screen 1480 is shown in FIG. 17.

Densities at the same coordinate on pages on which the same image in the same JOB is output are displayed as a list 1481 on the screen. Copy numbers, and respective densities in numerical value in R, G, and B corresponding to the copy number are displayed in the list 1481. Data to be displayed is acquired by searching the output image management table for elements matching the subject page in the JOB ID and the page number, and referring to the copy number and the output image read data of each of the corresponding elements.

A next item button 1482, a previous item button 1483, a “display screen image of selected page” button 1484, and a finish button 1485 are displayed for button depression on the all copy density display screen 1480.

A display extent on the list can be switched by a button depressing operation on the next item button 1482 and the previous page button 1483. The button depression operation on the finish button 1485 can finish the display of the all copy density display screen 1480, and can cause the all copy density display screen 1480 to transition to the image density check screen 1470.

Moreover, when a display area of each of the items in the list 1481 is depressed to select an arbitrary page, and depressing the “display screen image of selected page” button 1484, an image of the selected page is displayed on the image density check screen 1470, and the screen image of the subject page can be checked. As a result, if it is determined that the numerical value of the density is abnormal, the check of the state of the subject image is promoted.

Though the image density check screen 1470 and the all copy density display screen 1480 are described as independent screens in this embodiment, there may be provided such a configuration that the information on both the screens is displayed on the same screen, and the displayed screen image can be updated in real time by switching the selected JOB.

The check of the image density enables the check of a density difference among the images, which cannot be checked visually, and the like.

Though a description is given of the screen image display of the output image of the respective embodiments, such a form that the screen image display and the conventional sample sheet discharge function are used at the same time is conceivable.

For example, such a case that While output screen image images are displayed at a short cycle for roughly checking a layout, a print mode, and the like, and the conventional sample sheet discharge is carried out at a long cycle, thereby checking an image quality and a damage in detail, and such a case that the image is checked on the output screen image image, and the conventional sample sheet discharge is carried out for reserving history (samples) of the output are conceivable.

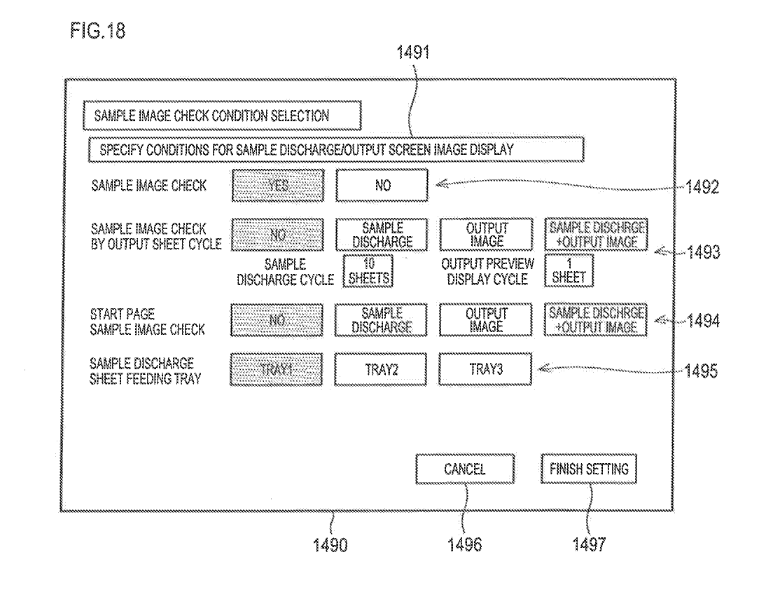

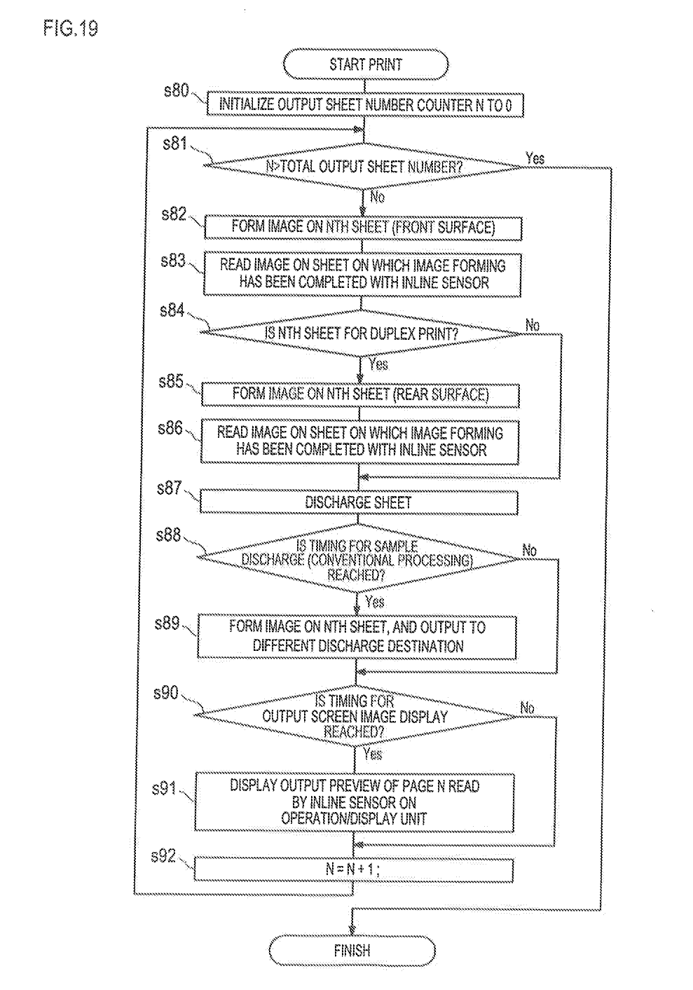

FIG. 18 shows a setting screen 1490 in a case where the conventional sheet discharge is used at the same time, and FIG. 19 shows a flow chart of a processing sequence in the case where the sample sheet discharge and the screen image display are used at the same time.

A message prompting specification of conditions for carrying out the sample sheet discharge and the output image screen image display is displayed on a message field 1491 on the setting screen 1490.

A button group 1492 for setting the sampling/image check are displayed for operation input on the setting screen 1490, and whether the sampling/image check are carried out or not can be selected. The executions are selected as Yeses, and a corresponding button is highlighted in the drawing.

A button group 1493 for setting the sampling/image check at a cycle of output sheet number are displayed for operation input on the setting screen 1490, and whether the sampling/image check at the output sheet number cycle is carried out or not can be selected. If the execution is selected, any one of only sample sheet discharge, only output screen image display, and the combination of the sample sheet discharge and output screen image display can be selected. Moreover, if the sample sheet discharge is selected, the sample sheet discharge cycle can be set to 10 sheets, for example. If the output screen image display is selected, the output screen image display cycle can be set to one sheet, for example. Namely, different cycles can be set to the sheet discharge sample and the output screen image display. If the output screen image cycle is set to one sheet, screen images of all the output images are displayed. In this example, such a setting that the sampling/image check is not carried out at the output sheet number cycle is provided.

Further, a button group 1494 for setting the sampling/image check for the start page are displayed for operation input on the setting screen 1490, and whether the sampling/image check on the start page is carried out or not can be selected. If the execution is selected, any one of only sample sheet discharge, only output screen image display, and the combination of the sample sheet discharge and output screen image display can be selected. In this example, such setting that check is not carried out is set.

Further, a sheet feeding tray can be selected when the sample sheet discharge is carried out on the setting screen 1490. For example, any one of trays 1, 2, and 3 can be selected.

A description will now be given of a processing sequence of simultaneously using the sample sheet discharge referring to the flowchart in FIG. 19. It should be noted that the following sequence is carried out by the control of the control CPU 113.

As the print (output) starts, the output sheet number counter N is set to 0 (Step s80) and it is determined whether N exceeds a total number of output sheets (Step s81). If N exceeds the total number of output sheets (Yes in Step s81), the processing is finished. If N does not exceed the total number of output sheets (No in Step s81), the image forming for the Nth sheet (front surface) is carried out (Step s82). Then, the inline sensor is caused to read the image on the sheet on which the image forming has been completed (Step s83).

After Step s83, it is determined whether duplex print is carried out for the Nth sheet or not after (Step s84). Whether the duplex print is carried out or not is recognized by the control CPU 113 for controlling the image forming apparatus. If the duplex print is not carried out (No in Step s84), the processing proceeds to Step s87, and the sheet is discharged. If the duplex print is carried out (Yes in Step s84), the image forming is carried out on the Nth sheet (rear surface) (Step s85), an image of the sheet on which the image forming is completed is read by the inline sensor (Step s86) and the sheet is discharged (Step s87).

Then, it is determined whether a timing for carrying out the sample sheet discharge is reached or not (Step s88). If the timing for carrying out the sample sheet discharge is not reached (No in Step s88), it is determined whether the execution timing of the screen image display of the output image is reached or not (Step s90). If it is determined that the timing for carrying out the sample sheet discharge is reached in Step s88 (Yes in Step s88), the image forming for the Nth sheet is carried out, and an output to a different discharge destination is carried out (Step s89). Then, it is determined whether a timing for carrying out the screen image display of the output image is reached or not (Step s90).

If it is determined that the execution timing for the screen image display of the output image is not reached (No in Step s90), 1 is added to N (Step s92), and the processing proceeds to Step s81. If it is determined that the execution timing for the screen image display of the output image is reached (Yes in Step s90), screen image of the output image of the Nth page read by the inline sensor is displayed on the operation/display unit (Step s91), 1 is added to N (Step s92), and the processing proceeds to Step s81.

As a result, the output image can be checked while the sample sheet discharge and the screen image display of the output image are simultaneously used, and generation of waste sheets and a decrease in productivity can be restrained while the image check by means of the sample sheet discharge function is enabled.

According to the embodiments described above, the cheek of an output image equivalent to the check carried out by the sample sheet discharge can be carried out without generation of wasteful sheets and a decrease in productivity. Furthermore, a reprint when an abnormality is found in the check of an output image can be easily carried out.

Though the present invention is described based on the embodiments, the present invention is not limited to the contents of the embodiments, and may be properly modified as long as the modification does not depart from the scope of the present invention.

### CROSS-REFERENCE TO RELATED APPLICATION

This application is based on Japanese Patent Application No. 2012-247926 filed with Japan Patent Office on Nov. 9, 2012, the entire content of which is hereby incorporated by reference.

What is claimed is:

1. An image forming apparatus comprising:
an image forming unit for forming an image on a sheet;
an image read unit for reading the output image on the sheet on which the image has been formed;
an operation/display unit for providing operation and display; and
a control unit for controlling the image forming apparatus,
wherein the control unit can display a screen image of the output image read by the image read unit on the operation/display unit.

2. The image forming apparatus according to claim 1, wherein the screen image is displayed on the operation/display unit so that a user checks the output image.

3. The image forming apparatus according to claim 1, wherein the control unit enables a display instruction for the screen image via the operation/display unit.

4. The image forming apparatus according to claim 1, wherein the control unit displays a screen image of the output image read last by the image read unit as an initial display when the output image is displayed as the screen image.

5. The image forming apparatus according to claim 4, wherein the control unit updates the display of the operation/display unit if the image read mat reads a new output image while the screen image of the output image is displayed on the operation/display unit, and displays a screen image of the newly read output image.

6. The image forming apparatus according to claim 1, wherein the control unit displays a screen image of the output image read first by the image read unit in a specific job as an initial display when the output image is displayed as the screen image.

7. The image forming apparatus according to claim 1, wherein the control unit enables specification of a specific output job via the operation/display unit relating to the display, and enables display of the screen image of the output image in a job relating to the specification on the operation/display unit.

8. The image forming apparatus according to claim 1, wherein the control unit enables specification of an arbitrary JOB/copy number/page via the operation/display unit relating to the display, and enables display of the screen image of the output image in a page relating to the specification on the operation/display unit.

9. The image forming apparatus according to claim 1, wherein the control unit enables, based on a specification of an arbitrary cycle, display of a screen image of an output image of a subject page on the operation/display unit.

10. The image forming apparatus according to claim 9, wherein the arbitrary cycle is any one of a number of sheets, a time, and a number of JOBs.

11. The image forming apparatus according to claim 1, wherein the control unit enables, based on a specification of a specific condition, display of a screen image of an output image on a page matching the condition on the operation/display unit.

12. The image forming apparatus according to claim 11, wherein the specific condition includes one or more conditions out of an operating user, an output mode, and an output destination.

13. The image forming apparatus according to claim 9, wherein the control unit enables the specification via the operation/display unit.

14. The image forming apparatus according to claim 1, wherein the control unit causes the image read unit to read all output images.

15. The image forming apparatus according to claim 1, wherein the control unit enables a specification of a page for which the output image is read via the operation/display unit, and causes the image read unit to read the output image when the specified page is output.

16. The image forming apparatus according to claim 1, wherein the control unit enables reprint of the output image displayed on the operation/display unit via the operation/display unit.

17. The image forming apparatus according to claim 16, wherein the control unit enables selection whether the reprint is output as an interruption JOB or a normal JOB via the operation/display unit.

18. The image forming apparatus according to claim 1, wherein the control unit enables a specification of a specific portion of the screen image via the operation/display unit, and enables display of image density information of the specified portion on the operation/display unit.

19. The image forming apparatus according to claim 1, herein the control unit enables a specification of a specific portion of the screen image via the operation/display unit, and enables listing of image density information on an other page, on which the same image as the image on a page relating to the specification is printed, on the operation/display unit.

20. The image forming apparatus according to claim 19, wherein the other page is the same page in a different copy from that of the page relating to the specification.

21. The image forming apparatus according to claim 19, Wherein the control unit enables a specification of an arbitrary page in the list via the operation/display unit, and enables display of a screen image of an output image of the specified page.

22. The image forming apparatus according to claim 1, wherein the control unit enables a change of a display scale of the screen image of the output image displayed on the operation/display t via the operation/display unit, and, if the screen image having the changed display scale exceeds a display area of the operation/display unit, enables a specification of an area of the screen image to be displayed on the display area.

23. The imago forming apparatus according to claim 1, wherein before all pages in a job have been output, the control unit enables display of a screen image of an output image read by the image read unit for a page already output in the job on the operation/display unit.

24. The image forming apparatus according to claim 1, wherein the control unit has a sample sheet discharge function, and enables a user to select either one of or both of the sample sheet discharge and screen image display of the output image read by the image read unit.
